(19) United States
(12) Patent Application Publication
(10) Pub. No.: US 2004/0153374 A1
(43) Pub. Date: Aug. 5, 2004

(54) Ticket reselling using software notes

(76) Inventor: Kerry S. Nelson, Shoreview, MN (US)

Correspondence Address: 3M INNOVATIVE PROPERTIES COMPANY, PO BOX 33427, ST. PAUL, MN, 55133-3427, US

(21) Appl. No.: 10/357,045

(22) Filed: Jan. 31, 2003

(51) Int. Cl. G06F 17/60

(52) U.S. Cl. 705/26

(57) ABSTRACT

A network-based ticket reselling system is described that makes use of “software notes” for the reselling of tickets. The ticket reselling system generates the software notes in response to ticket data from a seller that identifies one or more tickets for resale and request data from a buyer that indicates a desire to purchase tickets for an event. A first client device may execute notepad software to access the software note on the ticket reselling system and display at least one of the software notes to the buyer for accepting or rejecting an offer to sell the tickets. A second client device may execute notepad software to access the software notes on the ticket reselling system and display at least one of the software notes to the seller for accepting or rejecting an offer to buy the tickets.

### TECHNICAL FIELD

The invention relates to networked computer systems and, more particularly, computer systems for transacting the sale of tickets.

### BACKGROUND

The use of tickets is ubiquitous. Some form of a ticket, for example, is often required to view or attend an event, such as a sporting event, a theatrical production, a conference, a wine tasting, and the like. Tickets are also commonly used as a reservation mechanism, e.g., to secure a place on a flight, a cruise, a bus, and the like.

Often, a ticket holder cannot utilize a ticket for any of a myriad of reasons, such as a scheduling conflict or a cancellation of a babysitter. Moreover, often these reasons may arise at the last minute, making it difficult for the ticket holder to resell the ticket. As a result, tickets often go unused without the ticket holder being able to recover any part of the original ticket price.

With the advent of the Internet, numerous services have arisen having websites directed to the selling and reselling of tickets. These services typically post ticket information on web pages for access using a conventional web browser. To monitor for newly available tickets, a potential buyer is often required to frequently return to the website via the web browser. Other websites may require the user to provide personal contact information, such as an electronic mail address, and may send an electronic mail message when tickets are available.

### SUMMARY

In general, the invention provides a ticket reselling system that makes use of “software notes” for the reselling of tickets. The term software note, as used herein, refers to a digital version of a paper note that is commonly used for quick reminders. For example, Post-it® Software Notes from 3M Company of St. Paul, Minn. (“3M”), allows a user to create a digital version of the canary yellow sticky notes from 3M. The software notes provide functionality similar to the paper sticky note by enabling the user to create and display a digital note bearing a reminder message, and “stick” the note on his or her computer desktop. In addition, the user may send the software note to other users having the Post-it Software for immediate display.

The ticket reselling system described herein makes use of these digital software notes to facilitate the resale of tickets. More specifically, the system may utilize software notes to quickly communicate the availability of one or more tickets to potential buyers. When tickets become available for resale, the ticket reselling system may generate data to “post” a software note, e.g., on a central server. Upon detecting the newly posted note, remote software, e.g., Post-it Software Notes, may quickly display the note to an interested buyer, thereby facilitating the quick and efficient resale of the tickets. Similarly, when a buyer indicates a desire to purchase tickets for a particular event, the system may quickly display a software note to one or more ticket holders or a vendor that may have tickets for resale. As described herein, the software note may have embedded user inputs, such as graphical buttons with associated universal resource locators (URLs), for electronically effecting the transaction.

In one embodiment, the invention is directed to receiving ticket data from a seller that identifies one or more tickets for resale, and posting a software note at a ticket reselling system in response to the ticket data.

In another embodiment, the invention is directed to a computer-readable medium to receive ticket data from a seller that identifies one or more tickets for resale, and post a software note at a ticket reselling system in response to the ticket data.

In another embodiment, the invention is directed to a system comprising a database that stores ticket data from a seller that identifies one or more tickets for resale, and a server to access the ticket data and generate a software note in response to the ticket data.

The invention may provide one or more advantages. The use of digital software notes to facilitate the resale of tickets may allow a seller, such as a ticket holder or vendor, to more easily contact and present ticket information to potential buyers. In other words, the software notes may communicate the availability of one or more tickets to potential buyers more quickly than conventional techniques.

Furthermore, by posting software notes at the ticket reselling system for display to a buyer or seller, the techniques may reduce the need for direct communication between buyers and seller, e.g., electronic mail, prior to the transaction. In addition, the use of notepad software, as described further below, may offer the benefit that subscribers, e.g., sellers and buyers, need not necessarily provide private information to the ticket reselling system. For example, the subscribers need not provide personal electronic mail addresses or other private information. The notepad software may interrogate the ticket reselling system to determine whether any software notes have recently been generated, i.e., “posted,” and display any newly identified software notes on the user's desktop. Consequently, the ticket reselling system need not necessarily maintain contact information for each subscriber.

In addition, the user need not access an email application to view information concerning available tickets. Rather, the information appears within the note on the desktop of the user.

The above summary of the invention is not intended to describe every embodiment of the invention. The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example system that makes use of “software notes” for the reselling of tickets.

FIG. 2 is a block diagram illustrating an example embodiment of a ticket reselling system.

FIG. 3 illustrates an example software note presented to a buyer to indicate one or more tickets are available for resale.

FIG. 4 is a block diagram illustrating the various components that may reside upon a remote computing device through which a user interacts with the ticket reselling system.

FIG. 5 is a flowchart illustrating one example operation of the ticket reselling system in utilizing software notes to inform buyers of tickets available for resale.

FIG. 6 is a flowchart illustrating example operation of the ticket reselling system in which software notes are used to notify sellers of the potential to resell tickets.

FIG. 7 illustrates an example software note presented to a seller, e.g., a ticket holder or a vendor, to indicate that a buyer wishes to purchase one or more tickets.

### DETAILED DESCRIPTION

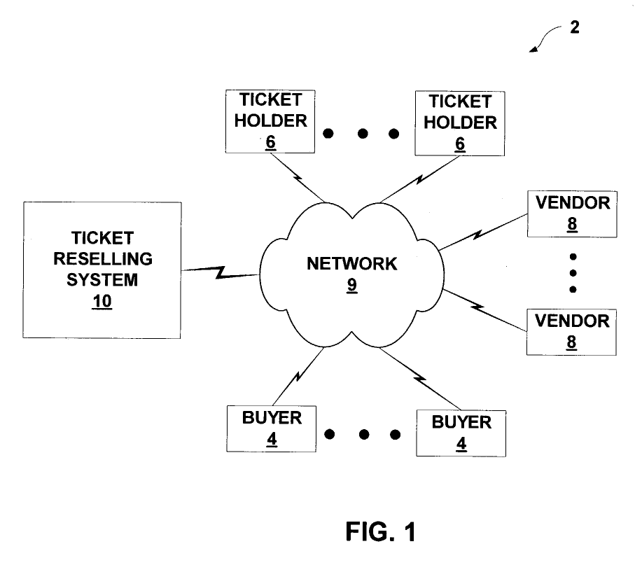

FIG. 1 is a block diagram illustrating an example computing environment 2 that makes use of “software notes” for the reselling of tickets. The term software note, as used herein, refers to a digital version of a paper note that is commonly used for quick reminders. For example, Post-it® Software Notes from 3M of Maplewood, Minn., is a digital version of the canary yellow sticky notes from 3M. The software notes provide functionality similar to the paper sticky note by allowing a user to create a digital note having a reminder, and “stick” the note on his or her computer desktop.

As described herein, digital software notes are used within computing environment 2 to facilitate the resale of tickets to buyers 4 from ticket holders 6, vendors 8, or both. In particular, software notes are used to quickly communicate the availability of one or more tickets to potential buyers 4. Computing environment 2 may also utilize software notes to quickly communicate the interests of a buyer to ticket holders 6 or vendors 8.

Ticket holders 6 represents individuals, groups of individuals, organizations, or the like that purchase tickets from vendors 8. Vendors 8 represent organizations that manage the sale of tickets for a sporting event, an art event, or a travel reservation. Example vendors include ticket offices of sport franchises, theaters, tournaments, cruise lines, airlines, travel offices, and the like. An event may include a sporting event, a theatrical production, a specific game within a tournament, a flight, a cruise, and the like. These events are typically scheduled for specific dates. Consequently, the tickets may “expire” when the date has passed. A ticket may be a more-conventional hard-copy form, or in electronic form, i.e., an “e-ticket.”

Often, a ticket holder 4 cannot utilize a ticket for any of a myriad of reasons, such as a scheduling conflict or a cancellation of a childcare provider. In these situations, a ticket holder 6 may elect to resell his or her ticket. Computing environment 2 may utilize software notes to inform buyers 4 as to the availability of tickets for resale using software notes. Alternatively or in addition, computing environment 2 may utilize software notes to inform ticket holders 6 or vendor 8 of an interested buyer 4. Furthermore, by interacting with the software notes, buyers 4, ticket holders 6, and vendor 8 may even complete the transaction, i.e., sell the tickets to interested buyers 4.

Buyers 4, ticket holders 6, vendors 8, may send software notes directly to each other via network 9 to facilitate the resale of tickets. For example, ticket holders 6 may send software notes to buyers 4 when new tickets become available for resale. As another example, buyers 4 may send notes directly to ticket holders 6 or vendors 8 to indicate their desire to purchase tickets designated for resale.

In addition, a ticket reselling system 10 may operate as a service provider that automatically “posts” software notes to indicate the availability of tickets for resale or the interests of buyers 4. As used herein, the term “post” is used to generally refer to making a software note available for access by buyers 4, ticket holders 6, and/or vendors 8. For example, ticket reselling system 10 updates data files, web pages, memo boards, or the like to reflect the newly created software notes.

Ticket reselling system 10 may post the software notes in a manner that is immediately accessible by subscribers to the service, i.e., buyers 4, ticket holders 6, vendors 8, or combinations thereof. Consequently, ticket reselling system 10 may reduce or eliminate the need for direct communication of software notes. In addition, ticket reselling system 10 may provide ticket reselling memo boards to which buyers 4, ticket holders 6, or vendors 8, or combinations thereof, post software notes. In either case, as described in further detail below, newly posted software notes may be displayed almost immediately to the subscribers.

Each subscriber may be required to pay a subscription fee, such as a monthly fee. In addition, ticket reselling system may charge a transaction fee for tickets resold through the service.

Each of buyers 4, ticket holders 6, and vendors 8 may interact with a computing device suitable for accessing network 9. Example devices include personal computers, laptop computers, personal digital assistants (PDAs) such as Palm™ organizers from Palm Inc. of Santa Clara, Calif., network-enabled wireless communication devices, such as cellular telephones, and the like.

To utilize software notes, the computing devices execute notepad software for managing software notes, such as Post-it® Software Notes from 3M. The notepad software interrogates ticket reselling system 10 to determine whether any software notes have recently been posted e.g., to a web page or data file. The notepad software may, for example periodically interrogate ticket reselling system 10. The notepad software displays any newly identified software notes to the buyer. This approach may offer the benefit that the subscribers need not provide private information to ticket reselling system 10. For example, the subscribers need not provide personal electronic mail addresses or other private information.

In addition, the notepad software acts as a note dispenser by which a user, e.g., a buyer 4, ticket holder 6, or vendor 8, can create a new software note and post the software note to ticket reselling system 10 for display to the other subscribers, e.g., via a web page administered and updated by system 10. This software also allows the user to directly communicate a newly created note to another user for display, provided a network address or electronic mail address of the other user is known.

The computing devices may also execute communication software, typically a web browser such as Internet Explorer™ from Microsoft Corporation of Redmond, Wash., in order to communicate with ticket reselling system 10. Network 9 represents any communication link suitable for communicating data, such as a wide-area network, local area network, or a global computer network like the Internet.

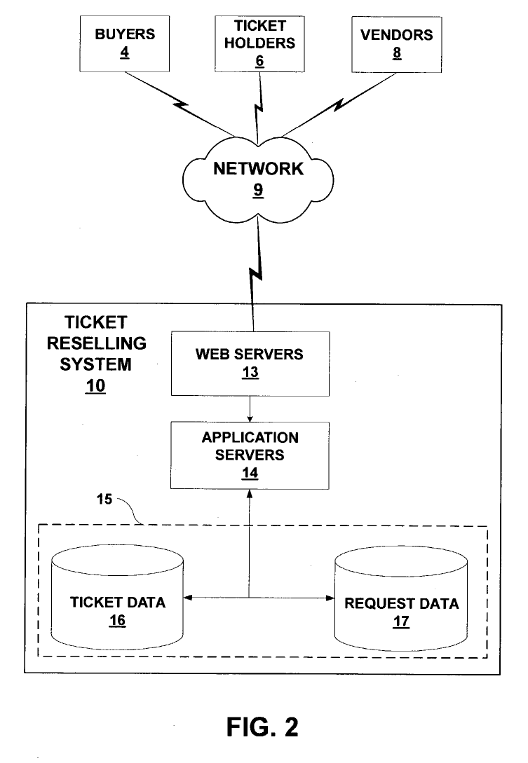

FIG. 2 is a block diagram illustrating an example embodiment of ticket reselling system 10. Web servers 13 provide a web-enabled interface for communicating with remote network users, e.g., buyers 4, ticket holders 6, and vendors 8 via network 9. By interacting with web servers 13, a user may specify ticket data 16 or request data 17 (collectively “data 15”). For example, a ticket holder 6 or a vendor 8 may provide ticket data 16 describing one or more tickets for resale. Example ticket data 16 includes a description of the event, an event date, a number of tickets, a location of each ticket, such as section and row, and an asking price. In addition, buyers 4 may provide request data 17 data that specifies an order to purchase tickets for resale. Request data 17 may describe the event, an event date, a requested number of tickets, a preferred location or locations for the tickets, an offering price, and other relevant data.

Application servers 14 provide an operating environment for software note subscription software that automatically generates and posts software notes to subscribers, e.g., buyers 4, ticket holders 6, and vendors 8, based on data 15. Application servers 14 may, for example, automatically post software notes viewable by registered buyers 4 when tickets become available for resale from tickets holders 6 or vendors 8. Application servers 14 may post software notes viewable by all registered buyers 4. Alternatively, application servers 14 may screen ticket data 16 for newly available tickets that match criteria set by buyers via request data 17, and generate individualized software notes viewable by specific buyers to notify the buyers that tickets matching their requests are available for purchase. In addition, application servers 14 may generate software notes to notify ticket holders 6 and/or vendors 8 that potential buyers are available to purchase tickets targeted for resale.

In one configuration, web servers 13 execute web server software, such as Internet Information Server™ from Microsoft Corporation, of Redmond, Wash. As such, web servers 13 and application servers 14 collectively provide a web-based environment in which buyers 4, sellers 6, and/or vendors 8 may interact. Web servers 13 and application servers 14 may execute a variety of software modules including Active Server Pages, Java scripts, Java Applets, Lotus scripts, web pages written in hypertext markup language (HTML) or dynamic HTML, extensible markup language (XML), component object module (COM) objects, and the like.

Data 15 may be stored in a variety of forms including data storage files, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management system. Data 15 could, for example, be stored within a single relational database such as SQL Server from Microsoft Corporation.

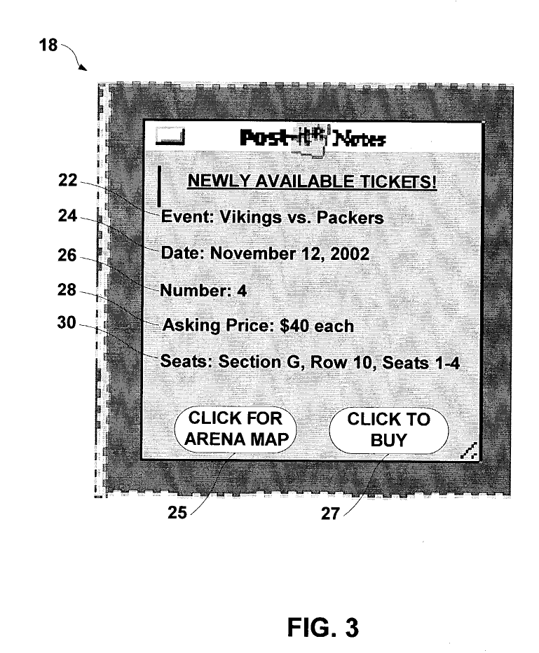

FIG. 3 illustrates an example software note 18 presented to a buyer 4 to indicate one or more tickets are available for resale. Specifically, a computing device for a buyer 4 displays software note 18 upon detecting the posting of the note by ticket reselling service 10, or upon directly receiving the note from a ticket holder 6 or a vendor 8.

As illustrated, note 18 indicates that one or more tickets are available for purchase by the buyer 4, and displays ticket data 16 (FIG. 2) associated with the newly available tickets. In this example, note 18 displays an event identifier 22 that describes the event, an event date 24, a number of available tickets 26, an asking price 28 set by the ticket holder 6 or vendor 8, and a location 30 of each ticket.

Note 18 further includes two graphical buttons 25, 27. By clicking on or otherwise selecting button 25, the buyer can view a graphical image illustrating the location of the tickets within the arena or other venue for the event. If the buyer 4 wishes to purchase any of the newly available tickets, he or she may select graphical button 27 to initiate the transaction.

Graphical buttons 25, 27 may be associated with respective universal resource locators (URLs) for servicing the response of the buyer. The URLs may, for example, cause the computing device currently displaying note 18 to launch the communications software, e.g., a web browser, and direct the communication software to a web page hosted by ticket reselling system 10. Graphical buttons 25, 27 are illustrated for purposes of example. Any input mechanism may be used, such as check boxes, text input areas, drop-down menus, hyperlinked text, and the like.

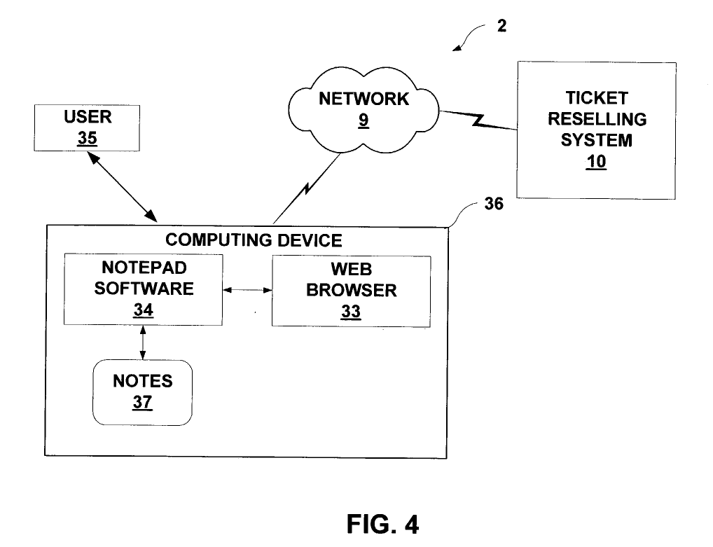

FIG. 4 is a block diagram illustrating the various components that may reside upon a remote computing device 36 through which user 35 interacts with ticket reselling system 10. User 35 may be, for example, a buyer 4, a ticket holder 6, or a vendor 8

Computing device 36 provides an operating environment for web browser 33 and notepad software 34, such as Post-it® Software Notes from 3M, for managing and displaying software notes 37. Notepad software 34 may comprise standalone program code, or may take the form of a “plug-in” that is invoked by web browser 33. In this form, notepad software 34 may comprise a client-side ActiveX module or Java Applet.

Notepad software 34 acts as a digital note dispenser by which user 35 can create a new software note 37, and post the software note to ticket reselling system 10 or send the note directly to another user. In other words, as a ticket holder 6 or a vendor 8, user 35 may interact with notepad software 34 to generate a software note describing tickets for resale, and may post the software note to ticket reselling system 10 or send the note directly to another user

In addition, notepad software 34 may interrogate ticket reselling service 10 to identify any newly posted software notes, and presents the software notes to user 35. As a buyer 4, user 35 may subscribe to a software notes service offered by ticket reselling system 10. Notepad software 34 may periodically interrogate ticket reselling system 10, download any newly identified software notes 37, and display the notes to user 35.

Notepad software 34 may display any newly received software notes 37 to user 35 using a “bum through” process described in United States Patent Application entitled “Payment Based Content Recipient Access to Software Notes Posted at Content Provider Site” having application Ser. No. 09/821,191, the content of which is hereby incorporated by reference. Using this process, notepad software 34 provides a border around a displayed note that allows the window or layer below the note to be seen. In this manner, newly posted notes “burn” through any currently active windows to expose a portion of the layer below the active window. Alternatively, notepad software may present the note to burn through all of the layers between the note and a desktop of client device 36. As another option, notepad software 34 may present newly posted notes to display newly posted content of interest, e.g., to be displayed within the burn through border around the note. Notepad software 34 may display a portion of a web page of ticket reselling system 10, for example, within the burn through area around a newly posted note presented by notepad software 34.

User 35 may interact with ticket reselling system 10 via web browser 33 to perform a variety of functions. User 35 may, for example, upload ticket data 16 or request data 17 to/from ticket reselling system 10 via web browser 33. In addition, user 35 may complete the resale of tickets via web browser 33. Interacting with a software note 37 may, for example, cause notepad software 34 to invoke web browser 33, and direct web browser 33 to a web page hosted by ticket reselling system 10, a vendor 8, or a third-party website, for completing the transaction.

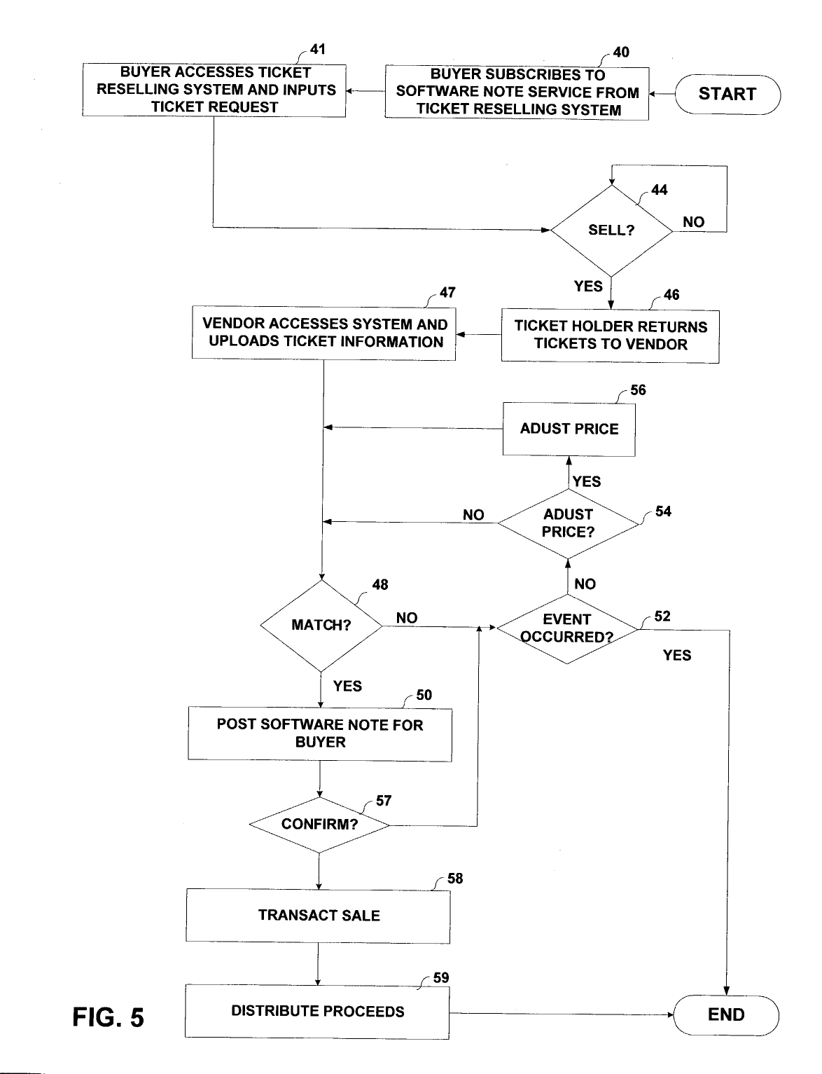

FIG. 5 is a flowchart illustrating one example operation of ticket reselling system 10 in utilizing software notes to inform buyers 4 of tickets available for resale. Initially, a buyer 4 may register with ticket reselling system 10 to subscribe to the software note service offered by the ticket reselling system (40). The buyer 4 may, for example, invoke web browser 33 (FIG. 4) to access a registration web page presented by web servers 13 (FIG. 2), and may provide a mechanism, e.g., a credit card, for payment of fees, such as a subscription fee or a transaction fee. In addition, buyer 4 may utilize web browser 33 to communicate request data 17 to ticket reselling system 10 to specify a request for one or more tickets (41). Buyer 4 may select, for example, an event of interest, and may specify the event date, a requested number of tickets, a preferred location or locations for the tickets, an offering price, and other relevant data.

In addition, a ticket holder 6 may elect to sell one or more tickets for an event previously obtained from a vendor 8, and may elect to return the tickets to a vendor 8 for resale (46). Upon receiving the tickets, the vendor 8 accesses ticket reselling system 10, and uploads ticket data 16 describing the available tickets (47). This activity need not occur subsequent to registration by the buyer (40,41) as illustrated in FIG. 5, but may occur previous to or in parallel with such actions.

Next, ticket reselling system 10 determines whether a match exists between the tickets requested by any of buyers 4 and the tickets made available for resale by vendors 8 (48). In particular, application servers 14 (FIG. 2) of ticket reselling system 10 determine whether the received request data 17 matches any available tickets specified by ticket data 16.

If no match occurs, i.e., no tickets match the requested event, purchase price, and other criteria specified by the buyer 4, ticket reselling system 10 may automatically adjust prices of available tickets based on the amount of time remaining until the event. If the event has not occurred (52), i.e., the tickets have not expired, ticket reselling system 10 determines whether any parties have enabled automatic price adjustment (54). For example, a ticket holder 6 or vendor 8 selling tickets may specify one or more negative (or positive) price adjustments based on the amount of time remaining (56). In this manner, the seller may allow the asking price to be automatically reduced (or increased) as the event approaches. Similarly, a buyer may specify one or more positive (or negative) adjustments to his or her offering price based on the amount of time remaining (56).

If ticket reselling system 10 finds a match between requests from one or more buyers 4 and tickets offered for resale by ticket holder 6 or vendor 8, the ticket reselling system posts one or more software notes to notify the buyers that tickets matching their requests are available for purchase (50). For example, ticket reselling system 10 may generate one or more software notes and post the generated software notes to web servers 13. Specifically, ticket reselling system 10 may generate one or more web pages or other content having one or more embedded software notes, and may locate the web pages in directories or folders associated with the matching buyers 4.

Once posted, notepad software 34 (FIG. 2) executing on the client device 36 of the buyer 4 interrogates web servers 13 and identifies the recently posted software notes and displays the software notes to the buyer, e.g., as illustrated by the example software note 18 of FIG. 3. Notepad software 34 may present the software note to buyer 4 using the burn-through process described above, which enables the software note to be immediately viewable by the buyer 4 without exiting the buyers active application. Once the software notes are presented to buyers 4 having matching orders, ticket reselling system 10 resells the tickets on a first-come-first serve basis. Specifically, one of the matching buyers 4 may confirm the purchase of the tickets, e.g., by selecting graphic icon 27 of note 18 (57). If the buyer 4 confirms the transaction, ticket reselling system 10 may complete the transaction by automatically debiting funds from the payment mechanism provided by the buyer, e.g., a credit card (58). Ticket reselling system 10 distributes the proceeds (59). For example, ticket reselling system 10 may distribute a portion to vendor 8 as well as to the original ticket holder 6. Ticket reselling system 10 may deduct a transaction fee, service fee, or other amount from the proceeds prior to distribution.

In this manner, ticket reselling system 10 may utilize software notes for quickly notifying buyers 4 of newly available tickets for resale, and for initiating an e-commerce transaction for completing the sale. In similar fashion, ticket reselling system 10 may utilize software notes to quickly notify a seller, e.g., a ticket holder 6 or vendor 8, that a potential buyer exists for purchasing tickets that he or she holds.

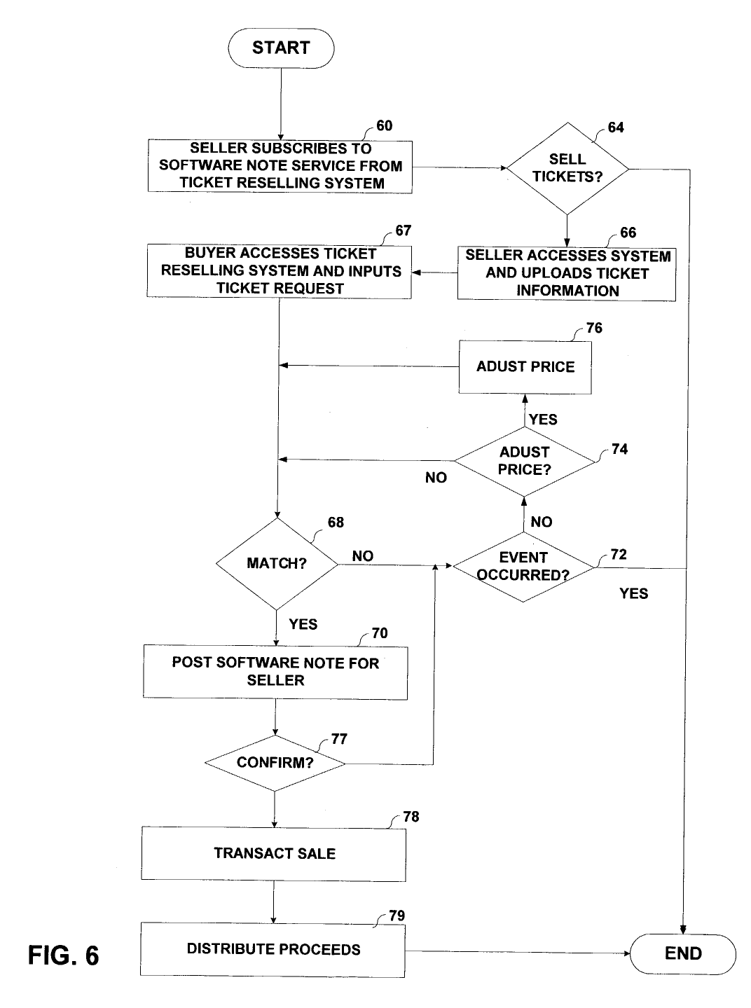

FIG. 6 is a flowchart illustrating example operation of ticket reselling system 10 in which software notes are used to notify sellers of the potential to resell tickets. Initially, a seller, e.g., ticket holder 6 or vendor 8, may register with ticket reselling system 10 to subscribe to the software note service offered by the ticket reselling system (60). The seller may, for example, invoke web browser 33 (FIG. 4) to access a registration web page presented by web servers 13 (FIG. 2), and may provide a mechanism, e.g., a credit card, for payment of fees, such as a subscription fee or a transaction fee.

Upon electing to sell one or more tickets (64), the seller utilizes web browser 33 to communicate ticket data 16 to ticket reselling system 10 to specify a request for one or more tickets for resale (66). In addition, buyer 4 utilizes web browser 33 to communicate request data 17 to ticket reselling system 10 to specify a request for one or more tickets (67). Buyer 4 may select, for example, an event of interest, and may specify the event date, a requested number of tickets, a preferred location or locations for the tickets, an offering price, or other relevant data.

Next, ticket reselling system 10 determines whether a match exists between the tickets requested by buyers 4 and the tickets made available for resale by the seller (68). In particular, application servers 14 (FIG. 2) of ticket reselling system 10 determines whether the received request data 17 matches any available tickets specified by ticket data 16.

If no match occurs, i.e., no ticket requests and associated offering prices have been provided by a buyer 4 that matches the tickets offered by the seller, ticket reselling system 10 may automatically adjust prices of available tickets based on the amount of time remaining until the event. If the event has not occurred (72), i.e., the tickets have not expired, ticket reselling system 10 determines whether any parties have enabled automatic price adjustment (74, 76).

If ticket reselling system 10 finds a match between the tickets offered for resale by the seller and a request provided by a buyer 4, the ticket reselling system posts one or more software notes to notify the sellers that a buyer has indicated an interest in his or her tickets. For example, ticket reselling system 10 may generate one or more software notes and post the generated software notes to web servers 13. Specifically, ticket reselling system may generate one or more web pages or other content having one or more embedded software notes, and may locate the web pages in directories or folders associated with the matching buyers 4.

Once posted, notepad software 34 executing on the client device 36 of the seller interrogates web servers 13 and identifies the recently posted software notes and displays the software notes to the seller, e.g., using the bum-through process described above. If the seller confirms the sale of the tickets, e.g., by selecting graphic icon 94 of note 80 (77), ticket reselling system 10 may complete the transaction by automatically debiting funds from the payment mechanism provided by the buyer, e.g., a credit card, and distributing the proceeds (78, 79).

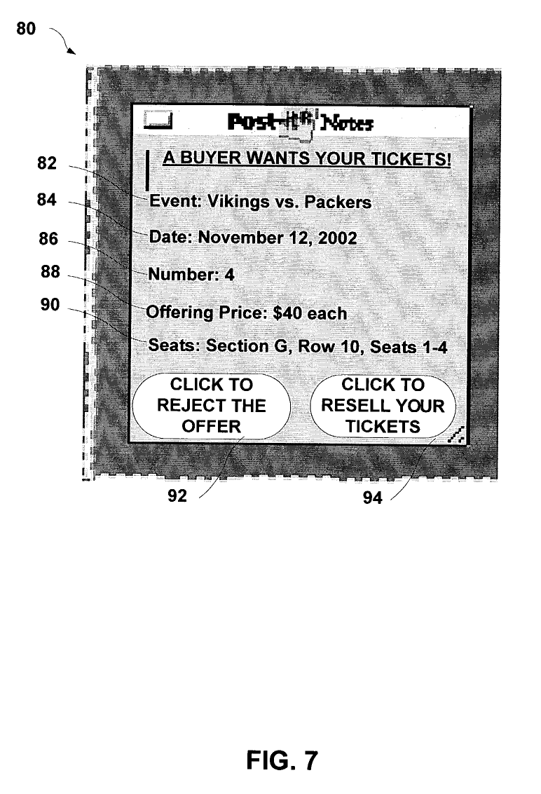

FIG. 7 illustrates an example software note 80 presented to a seller, e.g., a ticket holder 6 or a vendor 8, to indicate that a buyer wishes to purchase one or more tickets from him or her. Specifically, a computing device for the seller displays software note 80 upon detecting the posting of the note by ticket reselling service 10, or upon directly receiving the note from a buyer 4.

As illustrated, note 80 indicates that a buyer wishes to purchase one or more tickets from the seller. In this example, note 80 displays an event identifier 82 that describes the event requested by buyer 4, an event date 84, a number of desired tickets 86, an offering price 88 set by the buyer, and a location 90 of each requested ticket.

Note 80 further includes two graphical buttons 92, 94. By clicking on or otherwise selecting button 92, the seller can reject the offer. If the seller wishes to accept the offer, he or she may select graphical button 94 to initiate the transaction. Graphical buttons 92, 94 may be associated with respective universal resource locators (URLs) for servicing the response of the user. The URLs may, for example, cause the computing device currently displaying note 18 to launch the communications software, e.g., a web browser, and direct the communication software to a web page hosted by ticket reselling system 10. Graphical buttons 92, 94 are illustrated for purposes of example. Any input mechanism may be used, such as check boxes, text input areas, drop-down menus, hyperlinked text, and the like.

Various embodiments of the invention have been described. These and other embodiments are within the scope of the following claims.

1. A method comprising:
receiving ticket data from a seller that identifies one or more tickets for resale; and
posting a software note at a ticket reselling system in response to the ticket data.

2. The method of claim 1, further comprising:
receiving request data from a buyer that identifies one or more desired tickets;
determining whether a match exists between the desired tickets and the tickets for resale; and
posting the software note based on the determination.

3. The method of claim 2, wherein posting a software note comprises posting a software note for the seller indicating an offer from the buyer to purchase the tickets.

4. The method of claim 3, further comprising generating the software note to include an offer price from the buyer.

5. The method of claim 3, further comprising generating the software note to include user inputs for rejecting and accepting the offer.

6. The method of claim 3, further comprising:
receiving a response from the seller via interaction with the software note; and
transacting the sale of the tickets from the seller to the buyer based on the response.

7. The method of claim 1, wherein posting a software note comprises posting a software note for a buyer.

8. The method of claim 7, further comprising generating the software note to include an asking price from the seller.

9. The method of claim 7, further comprising generating the software note to include a user input for rejecting and accepting the offer.

10. The method of claim 9, further comprising:
receiving a response from the seller via interaction with the user input; and
transacting the sale of the tickets from the seller to the buyer based on the response.

11. The method of claim 2, wherein posting a software note comprises:
generating a software note based on one of the ticket data and the request data;
embedding the software note within a web page; and
presenting the web page using a web server hosted by the ticket reselling system.

12. The method of claim 2, wherein at least one of the ticket data and the request data specifies a price, the method further comprising:
automatically adjusting the price; and
regenerating the software note to indicate the adjusted price.

13. The method of claim 12, wherein automatically adjusting the price comprises:
determining an amount of time until expiration of the ticket; and
automatically adjusting the price based on the amount of time.

14. The method of claim 1, wherein receiving ticket data from a seller comprises receiving ticket data from a ticket holder.

15. The method of claim 1, wherein receiving ticket data from a seller comprises receiving ticket data from a vendor.

16. The method of claim 15, further comprising:
receiving a response via user interaction with the software note;
electronically transacting the sale of the tickets from the seller to the buyer; and
distributing at least a portion of proceeds from the transaction to the vendor.

17. A computer-readable medium comprising instructions thereon to cause a programmable processor to:
receive ticket data from a seller that identifies one or more tickets for resale; and
post a software note at a ticket reselling system in response to the ticket data.

18. The computer-readable medium of claim 17, further comprising instructions to cause the processor to receive request data from a buyer that identifies one or more desired tickets, determine whether a match exists between the desired tickets and the tickets for resale, and post the software note based on the determination.

19. The computer-readable medium of claim 17, further comprising instructions to cause the processor to post a software note for the seller indicating an offer from the buyer to purchase the tickets.

20. The computer-readable medium of claim 19, further comprising instructions to cause the processor to generate the software note to include an offer price from the buyer.

21. The computer-readable medium of claim 19, further comprising instructions to cause the processor to generate the software note to include user inputs for rejecting and accepting the offer.

22. The computer-readable medium of claim 19, further comprising instructions to cause the processor to receive a response from the seller via interaction with the software note, and transact the sale of the tickets from the seller to the buyer based on the response.

23. The computer-readable medium of claim 19, further comprising instructions to cause the processor to post a software note for the buyer.

24. The computer-readable medium of claim 23, further comprising instructions to cause the processor to generate the software note to include an asking price from the seller.

25. The computer-readable medium of claim 23, further comprising instructions to cause the processor to generate the software note to include user inputs for rejecting and accepting the offer.

26. The computer-readable medium of claim 25, further comprising instructions to cause the processor to receive a response from the seller via interaction with the inputs, and transact the sale of the tickets from the seller to the buyer based on the response.

27. The computer-readable medium of claim 18, further comprising instructions to cause the processor to generate a software note based on one of the ticket data and the request data, embed the software note within a web page, and present the web page using a web server hosted by the ticket reselling system.

28. The computer-readable medium of claim 18, wherein at least one of the ticket data and the request data specifies a price, and the instructions to cause the processor to automatically adjust the price, and regenerate the software note to indicate the adjusted price.

29. The computer-readable medium of claim 18, further comprising instructions to cause the processor to determine an amount of time until the expiration of the ticket, and automatically adjust the price based on the amount of time.

30. The computer-readable medium of claim 18, further comprising instructions to cause the processor to receiving ticket data from a ticket holder.

31. The computer-readable medium of claim 18, further comprising instructions to cause the processor to receive ticket data from a vendor.

32. The computer-readable medium of claim 18, further comprising instructions to cause the processor to receive a response via user interaction with the software note, electronically transact the sale of the tickets from the seller to the buyer, and distribute at least a portion of proceeds from the transaction to the vendor.

33. A system comprising:
a database to store ticket data from a seller that identifies one or more tickets for resale; and
a server to access the ticket data and generate a software note in response to the ticket data.

34. The system of claim 33, further comprising a client device executing notepad software to access the software note on the server, and display the software note to a user.

35. The system of claim 33, wherein the database stores request data from a buyer that identifies one or more desired tickets, and the server determines whether a match exists between the desired tickets and the tickets for resale, and posts the software note based on the determination.

36. The system of claim 33, wherein the server generates a software note for the seller indicating an offer from the buyer to purchase the tickets.

37. The system of claim 36, wherein the server generates the software note to include an offer price from the buyer.

38. The system of claim 36, wherein the server generates the software note to include user inputs for rejecting and accepting the offer.

39. The system of claim 36, wherein the server receives a response from the seller via interaction with the software note, and transacts the sale of the tickets from the seller to the buyer based on the response.

40. The system of claim 35, wherein the server generates a software note for the buyer.

41. The system of claim 40, wherein the server generates the software note to include an asking price from the seller.

42. The system of claim 40, wherein the server generates the software note to include user inputs for rejecting and accepting the offer.

43. The system of claim 42, wherein the server receives a response from the seller via interaction with the inputs, and transacts the sale of the tickets from the seller to the buyer based on the response.

44. The system of claim 42, wherein the server embeds the software note within a web page, and presents the web page to a user via a web server.

45. The system of claim 33, wherein the server automatically adjusts a price for the tickets, and regenerates the software note to indicate the adjusted price.

46. The system of claim 45, wherein the server determines an amount of time until the expiration of the ticket, and automatically adjusts the price based on the amount of time.

47. The system of claim 33, wherein the server receives a response via user interaction with the software note, electronically transacts the sale of the tickets from the seller to the buyer, and distributes at least a portion of proceeds from the transaction to the vendor.

48. A system comprising:
a ticket reselling system to generate software notes in response to ticket data from a seller that identifies one or more tickets for resale and request data from a buyer that indicates a desire to purchase tickets for an event;
a first client device executing notepad software to access the software note on the ticket reselling system and display at least one of the software notes to the buyer for accepting or rejecting an offer to sell the tickets; and
a second client device executing notepad software to access the software notes on the ticket reselling system and display at least one of the software notes to the seller for accepting or rejecting an offer to buy the tickets.

49. The system of claim 48, wherein the ticket reselling system comprises:
a database to store the ticket data and the request data; and
a server to access the ticket data and the request data and generate the software notes.

50. The system of claim 49, wherein the server determines whether a match exists between the desired tickets and the tickets for resale, and generate the software notes based on the determination.
